(19) United States
(12) Patent Application Publication
(10) Pub. No.: US 2023/0032350 A1
(43) Pub. Date: Feb. 2, 2023

(54) MOTORCYCLE CONTROL PROTECTIVE DEVICE

(71) Applicant: GERALD SAMMONS, ORLANDO, FL (US)

(72) Inventor: GERALD SAMMONS, ORLANDO, FL (US)

(21) Appl. No.: 17/390,914

(22) Filed: Jul. 31, 2021

(51) Int. Cl. B65D 81/05; B62J 23/00; B29C 41/14

(52) U.S. Cl. CPC B65D 81/053; B62J 23/00; B29C 41/14; B62K 23/06

(57) ABSTRACT

The invention relates to a protective device to be utilized on the handlebar of a vehicle equipped with control levers mounted on the handlebar adjacent to the handlebar grips. The device of the invention prevents control levers from imparting damage to the surroundings when the vehicle is transported. The device of the invention further protects the control levers and grips from damage by contact with nearby objects during transportation of the vehicle. The device of the invention further keeps a brake control lever in the fully pulled position, thus actuating the brake and preventing rotation of the braked wheel or wheels.

### BACKGROUND OF THE INVENTION

### Field of the Invention

The invention relates to the transportation of handlebar-controlled vehicles. More specifically, the invention relates to protective devices fitted to such vehicles during transport. Even more specifically, the invention relates to a device which protects the handlebar grip and adjacent control levers of such a vehicle from becoming damaged and protects the nearby objects from damage during transport.

### BRIEF SUMMARY OF THE INVENTION

The present invention discloses a sleeve device which is attached to the end of the handlebars of a vehicle, said vehicles including, but not limited to, bicycles, motorcycles, scooters, motorized tricycles, and all-terrain vehicles, said vehicles having grips installed at the ends of the handlebars and handlebar-mounted control levers adjacent to the grips. The device of the invention shields the grips and control levers, thus protecting the grips and levers from potential damage arising from unintended contact of the grips and levers with nearby objects during the transportation of the vehicle. The device also protects nearby objects, such as other vehicles and the surroundings, from potential damage by contact with the vehicle's grips or control levers. The device actuates the vehicle braking system by constraining the brake lever to its fully pulled position, preventing the braked wheel or wheels from rotating, thus minimizing movement of the vehicle during transport.

### BRIEF DESCRIPTION OF THE DRAWINGS

FIG. 1 shows a typical arrangement of handlebar, grip, and control lever on a vehicle with handlebars and handlebar-mounted control levers when the vehicle is not in use. A: handlebar; B: grip; C: control lever.

FIG. 2 reveals the grip with the lever pulled by the device of the invention in a CUT-AWAY VIEW. A: handlebar; B: grip; C: control lever; D: a non-limiting generic embodiment of the polymeric sleeve of the invention.

FIG. 3 illustrates the grip with the lever pulled by the device of the invention. A: handlebar; B: grip; C: control lever; D: a non-limiting generic embodiment of the polymeric sleeve of the invention.

FIG. 4 depicts the measurement of the optimal inner diameter (d) and inner length (I) of the sleeve of the invention based upon the characteristics of the vehicle to be fitted with the device.

FIGS. 5 and 6 depict different views of one non-limiting embodiment of the device of the invention. A sleeve of tough but flexible polymeric material is designed to fit over the grip and control lever of a vehicle with handlebars and handlebar-mounted control levers.

FIG. 7 shows a non-limiting embodiment of the invention with an external cushion, exploded view.

FIG. 8 shows a non-limiting embodiment of the invention with an external cushion affixed. D: sleeve; E: external cushion.

FIGS. 9 and 10 show different views of one non-limiting embodiment of the invention with an internal cushion, exploded view. This Figure shows the sleeve (D) and internal cushion (F).

FIG. 11 shows an embodiment of the invention with an internal cushion, cutaway view. This Figure shows one non-limiting way in which an internal cushion (F) may be fitted into the interior (G) of a sleeve (D).

FIG. 12 represents the cross-section of a mandrel to be used in the dip-molding manufacture of a non-limiting device of the invention. The cross-section has the shape of a flattened asymmetric tapered oval. The mandrel is manufactured by machine grinding of metal workpiece by techniques well known to those with ordinary skill in the art. The cross-section of said mandrel has a height h, a first width d1 and a second width d2. The shape and length of the mandrel are selected to provide a molded flexible, durable polymeric device with a unique shape designed to enclose and protect the grips and control levers of a vehicle.

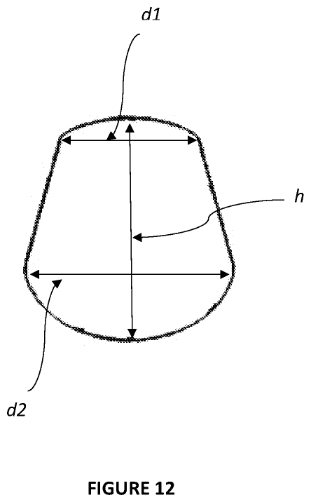

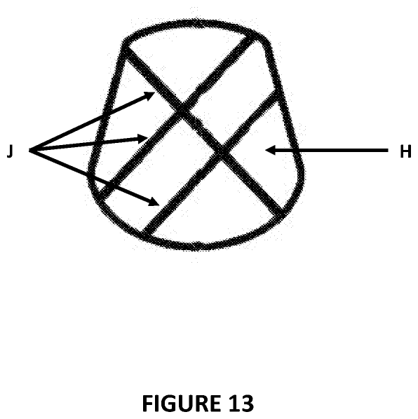

The said metal mandrel shown in FIG. 12 can be tooled by techniques well known to those with ordinary skill in the art so that the face of the mandrel has features which provide a product after dip-molding which has superior protective qualities. FIG. 13 depicts the face of a mandrel having a face H and tooled grooves J.

### DETAILED DESCRIPTION OF THE INVENTION

The invention relates to a protective device to be utilized on the handlebar of a vehicle equipped with control levers mounted on the handlebar adjacent to the handlebar grips. The device of the invention prevents the grips and control levers from imparting damage to the surroundings when the vehicle is transported. The device of the invention further protects the control levers and grips from damage by contact with nearby objects during transportation of the vehicle. The device of the invention further keeps a brake control lever in the fully pulled position, thus actuating the brake and preventing rotation of the braked wheel or wheels.

Many vehicles have a handlebar to control the movement of the vehicle. Such vehicles include, but are not limited to, bicycles, motorcycles, motorized tricycles, motorized scooters, and all-terrain vehicles. Many vehicles which have a handlebar to control the movement of the vehicle are fitted with grips at the end of the handlebar intended to be grasped by the operator and provide comfort and safety as the vehicle is driven, and may provide padding and vibration damping. Many grips have an additional control function. Such additional function may be, for example, in a grip well-known to those with skill in the art as a twist grip, to control the acceleration of a motorized vehicle. Another function of a twist grip may be to shift gears on a bicycle. Many vehicles which have a handlebar to control the movement of the vehicle are also fitted with control levers mounted adjacent to the grip and intended to be utilized while the hand is grasping the grip. These levers serve, for example, to actuate the clutch or a braking system.

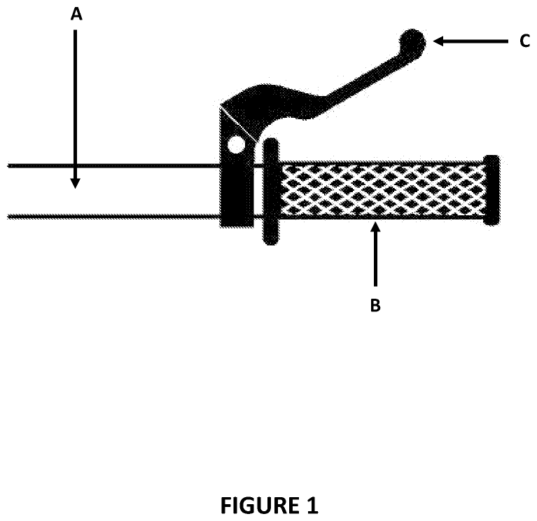

It is standard in the industry that motorcycle grips are mounted at the ends of a handlebar and lever controls extend from the handlebar which allow the operator to actuate the clutch and the front wheel braking apparatus. A typical arrangement of handlebar (A), grip (B), and control lever (C) is shown in FIG. 1. Most of the grips are made from polymeric material and may have decorative styling which might include stylized metal end pieces. Most levers are fabricated from metal. It is well known that when motorcycles are transported in a vehicle, the grips and levers may become damaged through contact with the surroundings. In addition, the grips and/or levers may impart damage to nearby objects. Often multiple motorcycles are transported together, and the grips and levers may become damaged by another motorcycle or the surroundings. Also, the grips and levers may cause damage to another motorcycle or the surroundings. Such damage occurs when the movement, jostling, and vibration inherent in transport causes the grips and levers to come into contact with another motorcycle or other nearby objects in the transport vehicle.

It is often desirable when transporting motorcycles, bicycles, or other vehicles with handlebars to minimize the potential for unintended movement of the vehicle. It is well known that one way to minimize unintended movement is to actuate the braking system so that rotation of the braked wheel or wheels is prevented. Several products to accomplish this are commercially available, and range from a simple clip mechanism, available from, inter aliA, RevZilla (Philadelphia), KiWav (Taipei, Taiwan), and BikersBitz (Bangkok, Thailand) to sturdy keyed locks such as those sold by, among others, Grip-Lock (Christchurch, New Zealand), Bully Locks (San Antonio, Tex.), or Oxford LeverLock (Whitney, Oxfordshire, England). With all of these devices, the brake lever is constrained in the fully actuated position, leaving the lever exposed with no protection, and capable of imparting damage to nearby objects during transportation.

Therefore, there is a need for a means to shield the grips and levers and protect them from damage to nearby objects and also to protect nearby objects from potential damage caused by contact with grips and/or levers.

There is a need for a means to prevent rotation of the braked wheel which also shields the grip and lever, minimizing unintended movement of the vehicle during transportation and protecting the grips and levers from damage due to contact with nearby objects and protecting nearby objects from potential damage due to contact with the grips and shields.

It is an object of the present invention to provide a device which covers the ends of the grips and the control levers of a handlebar-controlled vehicle, thus preventing damage to the vehicle's grips and levers due to contact with nearby objects during transportation of the vehicle.

It is a further object of the present invention to provide a device which covers the ends of the grips and the control levers of a handlebar-controlled vehicle, thus preventing damage to nearby objects due to contact with the grips and levers during transportation of the vehicle.

It is a further object of the present invention to provide a device which actuates the braking mechanism of a vehicle equipped with a handlebar-mounted braking lever, thus minimizing movement of the vehicle by preventing rotation of the braked wheel or wheels during transport.

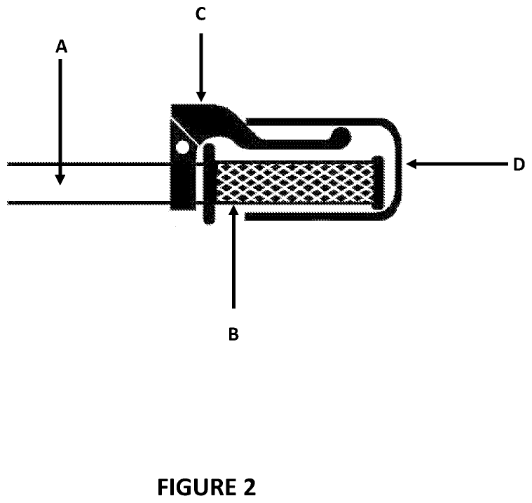

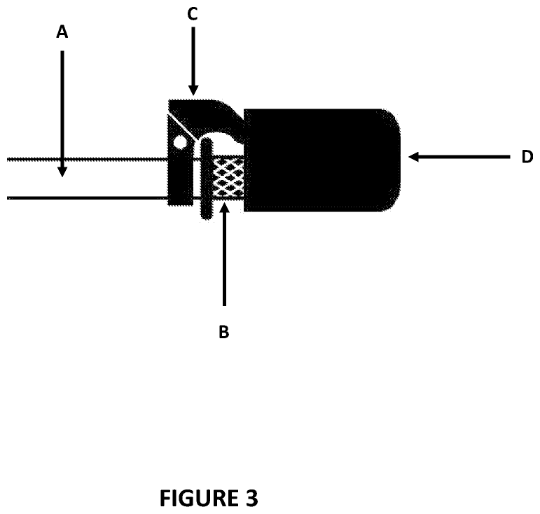

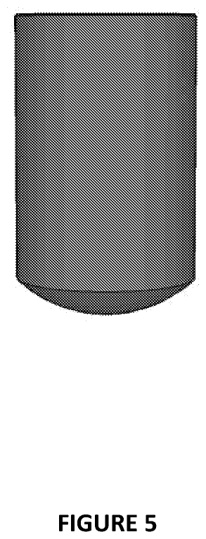

The device of the invention is fabricated from a flexible polymer essentially in the shape essentially that of a hollow right cylinder with a first open base and a second solid base. The invention is used by fully pulling the control lever mounted on a handlebar next to the grip, and sliding the open end of the device over the lever and grip. The applied device effectively covers the ends of both the grip and the control lever, providing the aforesaid protection. The spring mechanism in the control lever system forces the lever to hold the protective device in place. FIG. 2 depicts the device of the invention in use, showing the fully pulled control lever and the protective sleeve in a cutaway view. FIG. 3 depicts the device of the invention in use, showing the fully pulled control lever and the protective sleeve. The device of the invention, a sleeve with the shape essentially that of a right cylinder with a first open face and second closed face, fabricated from polymeric material, is shown in FIG. 5.

Several polymeric materials may be utilized to practice the invention, including, but not limited to, neoprene, vinyl, rubber, silicone, ethylene vinyl acetate, and low-density polyethylene. Many other polymeric materials exhibit acceptable attributes of flexibility, strength, and resistance to wear, which make them suitable for fabrication into the device of the invention, and are within the scope of the invention.

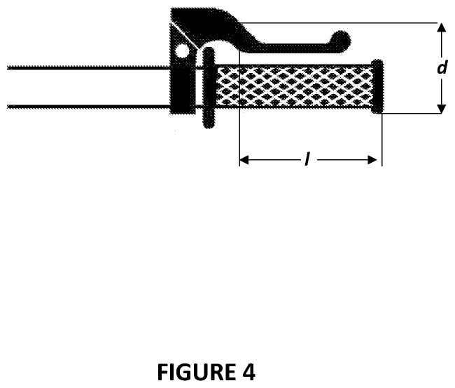

The dimensions of the polymeric sleeve of the invention are determined by the diameter of the handlebar, diameter and length of the grip, and the length and curvature characteristics of the lever. These dimensions may vary depending on the type and brand of the vehicle. Ideally, the inside diameter of the sleeve should be essentially equal to the distance between the outer surface of the fully pulled grip to the distal outer surface of the grip, measured at about ⅞ of the length of the grip. FIG. 4 denotes this distance as d. The inner diameter of the sleeve will vary from 1″ for vehicles with small levers and grips to 2¼″ for larger vehicles. A typical inner diameter is 1⅞″.

The inner length of the sleeve is ideally equal to about ⅞ of the full length of the grip, denoted in FIG. 4 as distance l. The inner length of the sleeve will vary from 2½″ for vehicles with small grips to 6″ for larger vehicles. A typical inner sleeve length is 4.0″.

The wall of the sleeve should be thick enough to provide protection of the grip and control lever from damage from interaction with nearby objects. The wall of the sleeve should be thick enough to provide protection from damage to nearby objects from the grip and control lever. The wall thickness is chosen to allow the sleeve to be flexible enough to stretch slightly upon installation and form a tight-fitting but easily removable sheath. The wall thickness can vary from 0.05″ to 0.10″. A typical wall thickness is 0.075″.

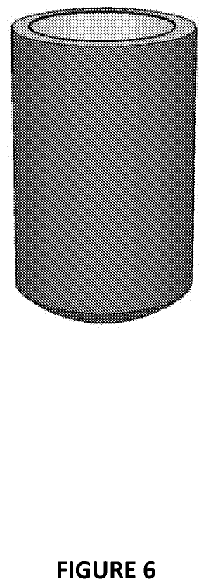

FIGS. 5 and 6 depict different views of a non-limiting embodiment of the invention.

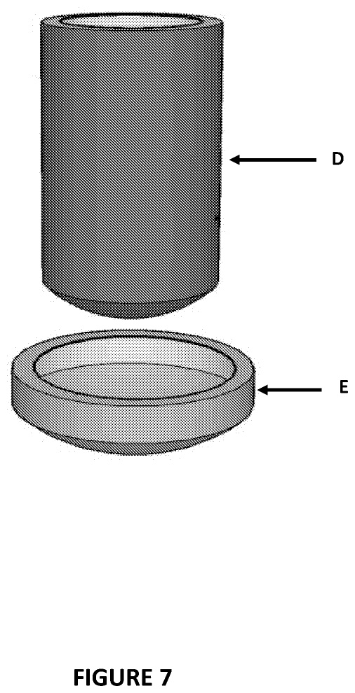

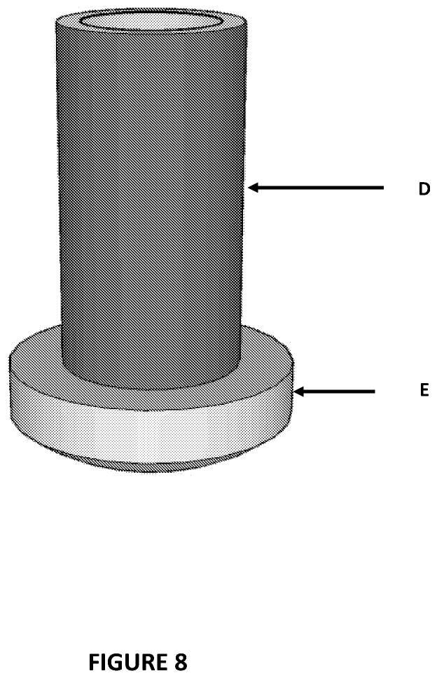

The device of the invention may be fitted with an additional element to augment its protective qualities. A reinforcing external cushion made from polymeric material can be affixed to the closed end of the sleeve. The polymeric material may be, but is not limited to, neoprene, vinyl, rubber, silicone, ethylene vinyl acetate, and low-density polyethylene. FIG. 7 illustrates a non-limiting example of an exterior cushion and the protective sleeve in an exploded view. As depicted in FIG. 8, the reinforced sleeve fitted with an external cushion may offer additional protection to the grip and lever, and to nearby objects.

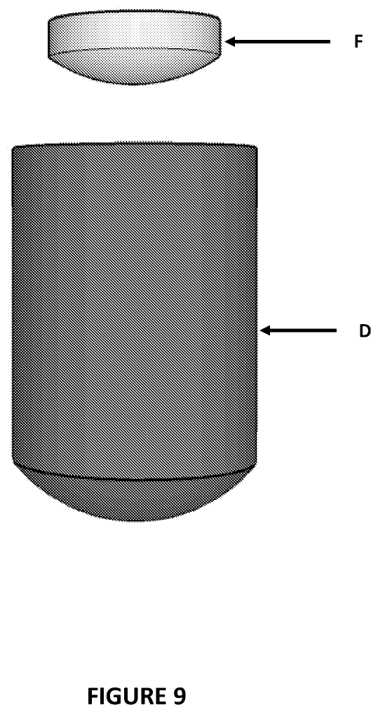

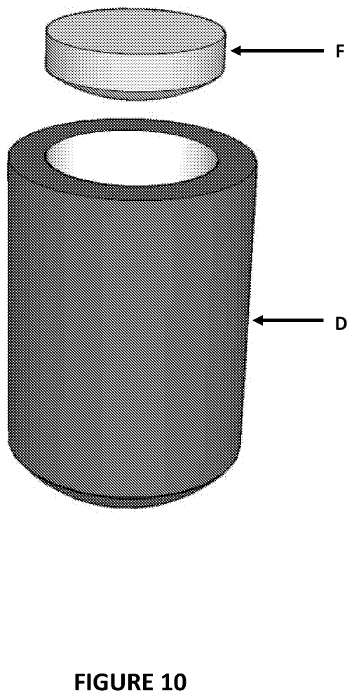

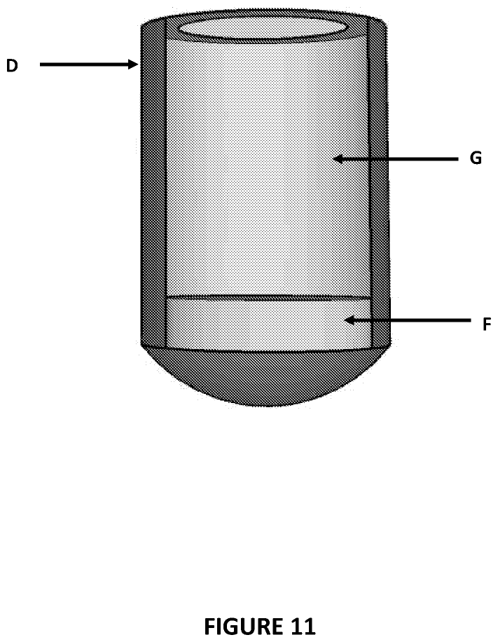

The device of the invention may also be reinforced by the addition of an interior cushion. The interior cushion may be fabricated from polymeric material. The polymeric material may be, but is not limited to, neoprene, vinyl, rubber, silicone, ethylene vinyl acetate, low-density polyethylene, and polyvinyl chloride/nitrile butadiene rubber/neoprene. The interior cushion should have a diameter which allows it to be inserted into the sleeve, as depicted in FIGS. 9 and 10. In one non-limiting embodiment of the invention, the interior cushion is affixed to the inner face of the base of the sleeve as shown in a cutaway view in FIG. 11.

In one non-limiting embodiment of the invention, a device is fabricated from polymeric material in the shape essentially that of a hollow right cylinder with a first open base and a second solid base. The device is manufactured by a dip-molding process well-known to those with skill in the art. A mandrel of the appropriate dimensions is selected, pre-heated, and dipped into a liquid polymer formulation. After the appropriate dwell time, the mandrel is removed from the liquid and the coated mandrel is heat cured. After cooling, the product is removed from the mandrel to provide the device of the invention having an inner diameter of 1.63″, an inner length of 4.0″, and a wall thickness of 0.075″.

In another non-limiting embodiment of the invention, the device manufactured by the aforementioned dip-molding process is fitted with an external cushion fabricated from a polymeric material which is attached to the closed end of the cylinder sleeve. The external cushion of this embodiment is manufactured by the aforementioned dip-molding process. The external cushion has a shape essentially that of a hollow right cylinder with a first open base and a second solid base, as graphically depicted in FIG. 6. The inner diameter of the external cushion is 1.70″. The height of the external cushion is 1.0″. The wall thickness of the external cushion is 0.075″. The external cushion is affixed to the closed face of the cylinder sleeve using cyanoacrylate adhesive, providing a device of the invention as depicted in FIG. 7. In this embodiment, the external cushion may be fabricated from a polymeric material which is different from that of the sleeve and which imparts different properties including, but not limited to, rigidity, flexibility, and resistance to wear.

In another embodiment of the invention, an external cushion is provided during the dip-molding process using techniques known to those with skill in the art. In this embodiment, a mandrel of the appropriate dimensions is lowered into the appropriate liquid polymer bath to a first depth and maintained for a first dwell time. Then the mandrel is partially extracted, leaving the bottom portion of the sleeve in the dip tank for a second dwell time. Then the mandrel is fully extracted, cured, and cooled. The article of this embodiment is then stripped or removed from the mandrel to provide a protective sleeve like that depicted in FIG. 8, with the sleeve and the exterior cushion fabricated from the same polymeric material.

In still another embodiment of the invention, a protective device with an internal cushion is provided. A circle is cut out from polymeric material such as, but not limited to, commercially available IA″ polyvinyl chloride/nitrile butadiene rubber/neoprene (chlorinated rubber) closed cell foam polymer to provide a cushion with essentially the shape of a right cylinder with diameter of 1.5″ and a height of IA″. The foam cushion is inserted into the sleeve produced by the aforementioned process and affixed to the bottom of the sleeve with cyanoacrylate adhesive, affording a device of the invention like that depicted in FIG. 11.

The object of the invention is to provide a flexible, durable protective polymer sleeve or sheath which is installed over the grips and control levers of a vehicle. After much experimentation, it was found that a sleeve with its cross-section in the shape of a flattened asymmetric tapered oval provided superior results. The said flattened asymmetric tapered oval cross-section, as depicted in FIG. 12, provides a device with a contour which gives a tight fit over the fully pulled control lever and grip, but is durable and flexible enough to be easily installed when the vehicle is to be transported, and easily removed. A mandrel can be fashioned by grinding techniques well known to one with ordinary skill in the art from any metal suitable for use in the dip-molding process including, but not limited to, steel and aluminum. A mandrel so fashioned is designed to have a cross-sectional shape as depicted in FIG. 12, with a height h, a first width d1, a second width d2. The mandrel has a length not depicted in FIG. 12. The height h is in the range of 1″ to 3″. Dimension d1 is in the range of ⅞″ to 2⅞″. Dimension d2 is in the range of ⅞″ to 2⅞″. The length of the mandrel is in the range of 4″ to 7″. A mandrel used to fabricate a protective device of the invention was fashioned from hot-rolled steel with height h of 2.0″, a first width d1 of 1¼″, a second width d2 of 1⅞″, and a length of 5.0″. In a non-limiting embodiment of the invention, said mandrel is used to manufacture a protective device by dip-molding into liquid vinyl plastisol to a depth of 4″, extraction of the coated mandrel from the dip tank, heat curing, and stripping the cured product from the mandrel. The product of this process is a flexible, durable vinyl sleeve with its interior dimensions identical to that of the mandrel, that is with height h of 2.0″, a first width d1 of 1¼″, a second width d2 of 1⅞″, and a length of 4.0″.

The end face of the mandrel, the face which is to be immersed in liquid polymer, may be further modified by machining techniques well known to one of ordinary skill in the art. Further modifications include, but are not limited to, the introduction of spikes, grooves, waffle patterns, crosshatch patterns, holes, nubs, and corrugation. The purpose of such modifications is to introduce unique features to the product after die-molding. These unique features enhance the performance of the product by providing more resilience of the polymer at the inside face of the sleeve endcap. In one non-limiting example, grooves were machined into the mandrel face to give a pattern as depicted in FIG. 13. The face H has grooves J. Face H has height h of 2.0″, a first width d1 of 1¼″, a second width d2 of 1⅞″, grooves J 3/16″ wide and 3/16″ deep. The mandrel has a mandrel length of 5.0″. The groves in the mandrel provide ridges in the product sleeve complimentary to the grooves. In a non-limiting embodiment of the invention, said modified mandrel is used to manufacture a protective device by dip-molding into liquid vinyl plastisol to a depth of 4″, extraction of the coated mandrel from the dip tank, heat curing, and stripping the cured product from the mandrel. The product of this process is a flexible, durable vinyl sleeve with its interior dimensions identical to that of the cross-section of the mandrel, that is with height h of 2.0″, a first width d1 of 1¼″, a second width d2 of 1⅞″, and an external length of 4.0″, with ridges on the interior end face 3/16″ wide and 3/16″ high in a pattern complimentary to the face H of the modified mandrel.

I claim:

1. A protective device fabricated from polymeric material, essentially in the shape of a hollow right cylinder with a first base, a second base, an inner length, and a thickness, wherein the said first base is open.

2. The device of claim 1 wherein the said polymeric material is chosen from the set consisting of neoprene, vinyl, rubber, silicone, ethylene vinyl acetate, and low-density polyethylene, and wherein the said first base and the said second base have an inner diameter in the range of 1″ to 2¼″, and wherein the said inner length is in the range of 2½″ to 6.0″, and wherein the said thickness is in the range of 0.05″ to 0.10″.

3. The device of claim 1 wherein the said polymeric material is vinyl, and wherein the said first base and the said second base have an inner diameter of 1.6″, and wherein the said inner length is 4.0″, and wherein the said thickness is 0.075″.

4. The device of claim 3 further comprising an external cushion fabricated from vinyl affixed to the said second base, essentially in the shape of a hollow right cylinder with a first cushion face, a second cushion face, a height, and a thickness, and wherein the said first cushion face and the second cushion face have a diameter of 1.7″, and wherein the said height is 0.75″, and wherein said thickness is 0.075″.

5. The device of claim 3 further compromising an interior cushion affixed to the interior face of the said base, fabricated from a polymeric material chosen from the set consisting of neoprene, vinyl, rubber, silicone, ethylene vinyl acetate, low-density polyethylene, and polyvinyl chloride/nitrile butadiene rubber/neoprene foam.

6. The device of claim 5 wherein the said interior cushion is fabricated from polyvinyl chloride/nitrile butadiene rubber/neoprene foam essentially in the shape of a right cylinder with a diameter of 1.5″ and a height of 0.5″.

7. A protective device manufactured by a dip-molding process fabricated from vinyl plastisol using a mandrel with a mandrel face and a mandrel length, said mandrel face being a flattened asymmetric tapered oval with a height of 2.0″, a width of 1⅞″ at its widest point, and said mandrel face containing a plurality of grooves 3/16″ wide and 3/16″ deep, said protective device having a thickness of 0.075″, a first device face being a flattened asymmetric tapered oval and a second device face being a flattened asymmetric tapered oval, and wherein said first device face is open, and wherein the interior cross-section of said device has the shape of a flattened asymmetric tapered oval with a height of 2.0″, a width of 1⅞″ at its widest point, and wherein the interior of the second device face has a plurality of ridges 3/16″ wide and 3/16″ high, corresponding to the contour of said mandrel.
